(19) United States
(12) Patent Application Publication
(10) Pub. No.: US 2026/0118172 A1
(43) Pub. Date: Apr. 30, 2026

(54) APPARATUSES AND METHODS FOR COMPUTER TOMOGRAPHY IMAGING SPECTROMETRY

(71) Applicant: Sony Group Corporation, Tokyo (JP)

(72) Inventors: Simon AMANN, Stuttgart (DE); Alexander GATTO, Stuttgart (DE); Mazen MEL, Stuttgart (DE)

(73) Assignee: Sony Group Corporation, Tokyo (JP)

(21) Appl. No.: 19/119,432

(22) PCT Filed: Oct. 10, 2023
(86) PCT No.: PCT/EP2023/078090

§ 371 Date: Apr. 9, 2025

(30) Foreign Application Priority Data
Oct. 16, 2022 (EP) 22201760.0

(51) Int. Cl. G01J 3/02; G01J 3/28

(52) U.S. Cl. CPC G01J 3/0229; G01J 3/0208; G01J 3/0294; G01J 3/2823; G01J 2003/2826

(57) ABSTRACT

The present disclosure relates to a computed tomography imaging spectrometer apparatus, the CTIS apparatus comprising at least one dispersive element at a first rotated state to generate a first sub-image of a scene, wherein the first sub-image is a dispersed image. Down-stream to the dispersive element, an image sensor configured to detect a CTIS image comprising the first image that is dispersed and a second sub-image, wherein the CTIS apparatus is configured to generate the first sub-image for a first rotated state of the dispersive element and to generate the second sub-image for a second rotated state of the dispersive element, for another dispersive element, or for no dispersive element.

### FIELD

The present disclosure generally relates to apparatuses for computed tomography imaging spectrometry (CTIS) and, more particularly, to improved optics and image reconstruction processing for CTIS.

### BACKGROUND

Spectral images have 3-dimensional (3D) information; one dimension is wavelength (λ), and the other two dimensions are spatial coordinates (x, y). Hyperspectral imaging (HSI) is referred to as the acquisition of images with more than the classical color channels red, green and blue (RGB). Since a hyperspectral image has more spectral channels, the acquired spectrum is more precise than the spectrum of an RGB image. This allows to distinguish colors and thus materials that might look the same in RGB.

The computer tomography imaging spectrometer (CTIS) is a snapshot device for hyperspectral imaging. Other common hyperspectral systems achieve similar performance, for example, by using color filters to distinguish between spectral bands. In comparison, CTIS uses one or more dispersive elements to spectrally smear spectral and spatial information of a scene onto a 2-dimensional (2D) spatial sensor plane along several projection directions. The dispersive element is traditionally a diffractive optical element integrated into underlying optics that creates a set of diffraction orders (e.g., 0^{th} order, 1^{st} order, etc.). Usually, the 0^{th} order forms a sub-image that is not smeared and provides spatial information, while higher orders, particularly the 1^{st} order, form sub-images that are smeared, or spectrally dispersed (e.g., from violet to red for a visible wavelength range) and additionally provide spectral information. Such an approach without a color filter has the benefit that no light is absorbed intentionally. The spectral and spatial information can be projected and imaged simultaneously by a monochromatic sensor. A reconstruction of the resulting image is then necessary to obtain the desired hyperspectral image (computational imaging). The hyperspectral image containing spatial and spectral information is a 3D data cube (x, y, λ) determined on the basis of the several projections.

Traditional CTIS has two big disadvantages. One is the low light efficiency. The entrance pupil of the optics is rather small compared to the detector size due to the fact that the sub-image size is also small (e.g., only 1/100 of the sensor area). Another problem is that the projections (spectrally smeared images of the scene) cannot be placed arbitrarily but must be arranged around the zeroth order. There is usually a significantly large unused area between the zeroth order and the projections. In other words, the fill-factor of a detection space is very low. An improvement in fill-factor would lead to more information related to an object or scene to be included in the imaging process without significantly increasing the requirements for processing.

To reconstruct a 3D hyperspectral image from a 2D CTIS image, iterative algorithms have been applied so far, such as Expectation Maximization (EM) or the Multiplicative Algebraic Reconstruction Technique (MART), for example. Unfortunately, they suffer from the disadvantage of being very time consuming, which is problematic in real-time applications based on the processing of hyperspectral data.

Thus, there is a demand for improved CTIS concepts.

### SUMMARY

This demand is addressed by apparatuses in accordance with the independent claims. Possibly advantageous embodiments are addressed by the dependent claims.

According to a first aspect, the present disclosure proposes a CTIS apparatus. The CTIS apparatus comprises at least one dispersive element at a first rotated state to generate a first sub-image of a scene. The first sub-image is a dispersed image. The CTIS apparatus also comprises, downstream to the dispersive element, an image sensor configured to detect a CTIS image comprising the first sub-image that is dispersed and a second sub-image. The CTIS apparatus is configured to generate the first sub-image for a first rotated state of the dispersive element and to generate the second sub-image for a second rotated state of the dispersive element, for another dispersive element, or for no dispersive element.

According to a second aspect, the present disclosure proposes a CTIS method. The method includes generating a first dispersed sub-image of a scene with at least one dispersive element at a first rotated state. The method also includes generating a second sub-image of the scene for a second rotated state of the dispersive element, for another dispersive element, or for no dispersive element. The method further includes detecting a CTIS image comprising the first dispersed sub-image and the second sub-image.

According to a third aspect, the present disclosure proposes a CTIS apparatus. The CTIS apparatus comprises a plurality of apertures configured to limit a respective area of a scene over which light is collected. A first of the plurality of apertures has associated therewith a dispersive element configured to generate a first sub-image of the scene that is dispersed. A second of the plurality of apertures has associated therewith a second sub-image of the scene. The CTIS apparatus further comprises, downstream to the plurality of apertures and the at least one dispersive element, an image sensor configured to detect a CTIS image comprising the first and second sub-images.

According to a fourth aspect, the present disclosure proposes a CTIS method. The CTIS method includes providing a plurality of apertures configured to limit a respective area of a scene over which light is collected. A first of the plurality of apertures has associated therewith a dispersive element configured to generate a first sub-image of the scene that is dispersed. A second of the plurality of apertures has associated therewith a second sub-image of the scene. The CTIS method further includes detecting a CTIS image comprising the first and second sub-images with an image sensor downstream to the plurality of apertures and the at least one dispersive element.

According to a fifth aspect, the present disclosure proposes a CTIS apparatus. The CTIS apparatus comprises a rotatable dispersive element and an actuator configured to rotate the dispersive element from a first rotation state to a second rotation state. The first rotation state of the rotatable dispersive element has associated therewith a first dispersed image and the second rotation state has associated therewith a second dispersed image. Downstream to the dispersive element, the CTIS apparatus further comprises an image sensor configured to capture the first dispersed image at a first time and to capture the second dispersed image at a subsequent second time.

According to a sixth aspect, the present disclosure proposes a CTIS method. The CTIS method includes rotating a dispersive element from a first rotation state to a second rotation state. The first rotation state of the rotatable dispersive element leads to a first dispersed image of a scene and the second rotation state leads to a second dispersed image of the scene. The CTIS method includes capturing the first dispersed image at a first time and capturing the second dispersed image at a subsequent second time.

### BRIEF DESCRIPTION OF THE FIGURES

Some examples of apparatuses and/or methods will be described in the following by way of example only, and with reference to the accompanying figures, in which

FIG. 1A shows an optical setup of a conventional CTIS apparatus;

FIG. 1B shows a further embodiment of a CTIS apparatus;

FIG. 1C shows a further embodiment of a CTIS apparatus;

FIG. 1D shows different configurations for the dispersive element as a grism;

FIG. 2A shows a further embodiment of a CTIS apparatus depicted at two different time instances, wherein the dispersive element has been rotated between a first time and a second time;

FIG. 2B shows a combined CTIS image based on the CTIS apparatus;

FIG. 2C shows a collection of eight sub-images based on the CTIS apparatus, each with a corresponding rotation angle of the dispersive element and detected at a corresponding time.

FIG. 2D shows a further combined CTIS image comprising the eight sub-images depicted in FIG. 2C based on the CTIS apparatus;

FIG. 3A shows a further embodiment of a CTIS apparatus, wherein the apparatus has a first aperture and a second aperture, each aperture having associated therewith a dispersive element, respectively;

FIG. 3B shows a combined CTIS image based on the CTIS apparatus of FIG. 3A;

FIG. 3C shows a further embodiment of a CTIS apparatus, wherein the apparatus has a first aperture and a second aperture, wherein the first aperture has associated therewith a dispersive element and the second aperture has associated therewith an optical path without a dispersive element;

FIG. 3D shows a combined CTIS image based on the CTIS apparatus of FIG. 3C;

FIG. 3E shows a further combined CTIS image for CTIS apparatus and a corresponding matrix of apertures, each aperture corresponding to a dispersive element or grism;

FIG. 3F shows a further embodiment of a CTIS apparatus, wherein the apparatus has a plurality of apertures arranged in an M×N matrix;

FIG. 3G shows a combined CTIS image for the CTIS apparatus of FIG. 3F and a corresponding M×N matrix of multiple apertures, each aperture corresponding to a dispersive element or grism;

FIG. 4A shows a further embodiment of a CTIS apparatus;

FIG. 4B shows a Keplerian design of the CTIS apparatus of FIG. 4A;

FIG. 4C shows a Galilean design of the CTIS apparatus of FIG. 4A

FIG. 5 schematically illustrates a neural network architecture for the production of a super-resolution hyperspectral (SR-HS) cube from an input of CTIS measurements based on the present disclosure;

FIG. 6A schematically illustrates the architecture of a learned back-projection operation of the post-processing scheme in FIG. 5; and

FIG. 6B schematically illustrates a 3D sub-pixel convolution module of the post-processing scheme in FIG. 5.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

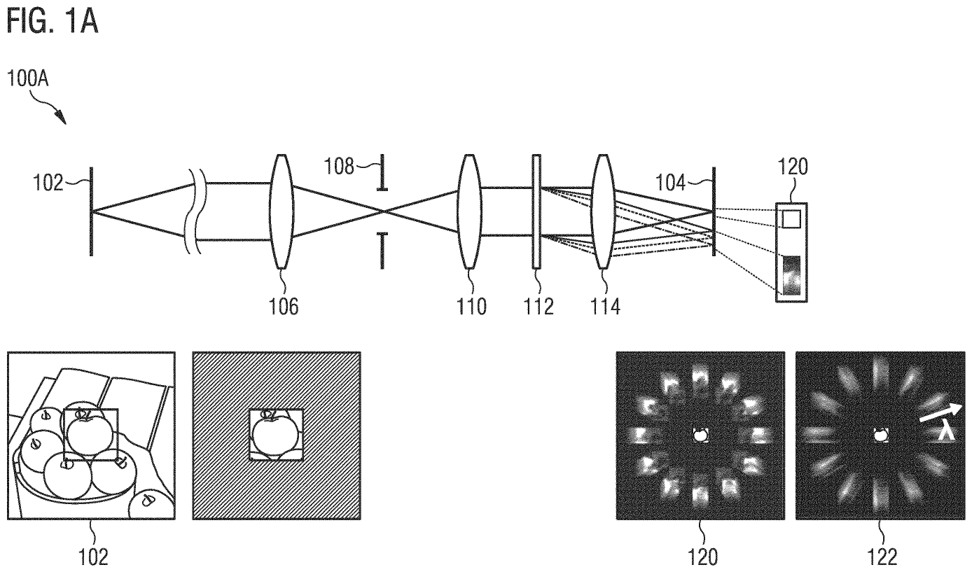

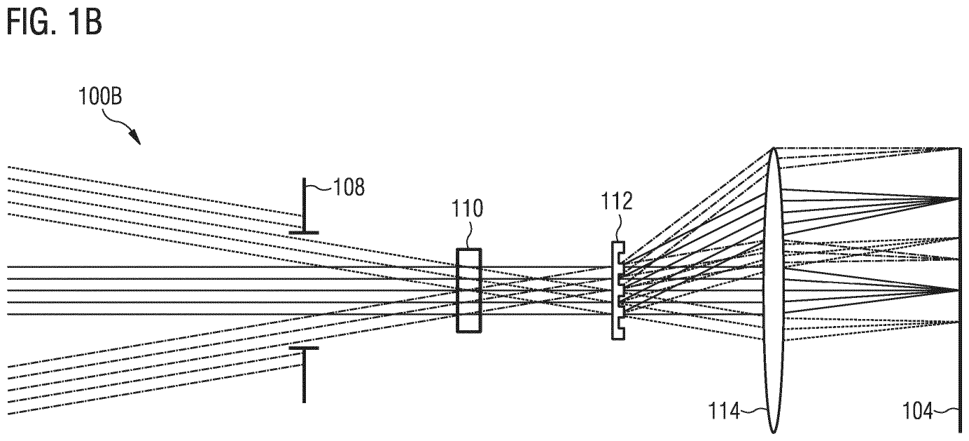

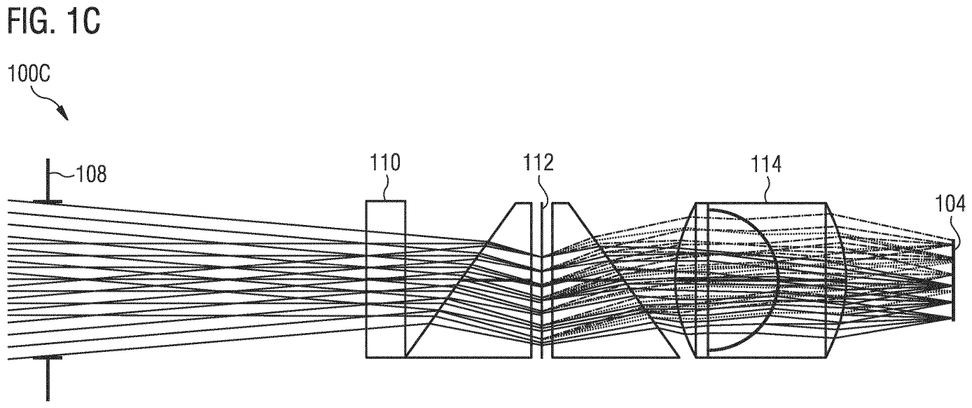

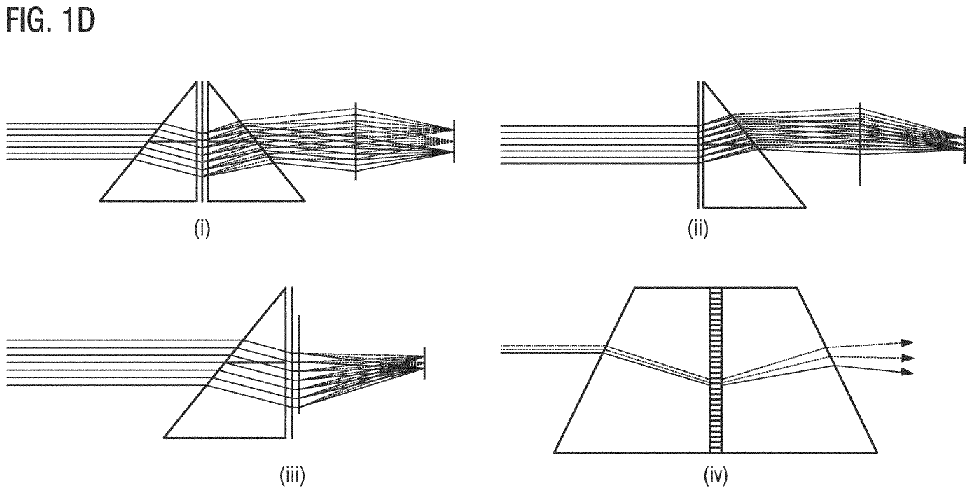

FIG. 1A shows a conventional design of an optical system for a CTIS apparatus 100A. Light emanating from an object/scene 102 on the left, is going through the system where it is spectrally dispersed and is then imaged onto an image sensor 104 (camera, CCD, CMOS sensor, etc.) on the right. A first lens, objective 106 of the CTIS apparatus 100A, creates an intermediate image. This intermediate image of the first lens 106 is cropped using an aperture 108, a hole or opening through which light travels, downstream to the first lens 106. The aperture 108 has a specified diameter to act as a field stop, limiting the amount of light that continues to travel through the optical system, thus cropping the intermediate image. This cropping is used to make space for spectrally dispersed sub-images within a CTIS image 120 on a detection area of the image sensor 104. A second (collimating) lens 110 downstream to the aperture 108 collimates the light which is then spectrally dispersed by a dispersive element 112 (e.g., grating, prism, computer generated hologram) downstream to the second lens 110. A third (re-imaging) lens 114 downstream to the dispersive element 112 images the light onto the image sensor 104. For the case of a diffractive optical element 112, the CTIS image 120 can then be detected by the image sensor 104. The image may be a monochromatic image, as depicted by 122. The image is then converted into an electrical signal and sent to a processing unit to generate a hyperspectral image.

In such conventional optical setups for CTIS, usually only one dispersive element creates multiple spectrally dispersed sub-images, as well as a non-dispersed sub-image in a central location, as shown in the CTIS image 120. Diffractive optical elements generate multiple orders of diffraction with a significant gap, particularly between the zeroth and first orders. This leads to a large detection area of the image sensor 104 to be left unused. In the traditional CTIS setup of FIG. 1A, the cropping of the intermediate image by the aperture 108 helps to make space for spectrally dispersed sub-images on the detection area of the image sensor 104 but cannot prevent the gap to be generated with the multiple orders of diffraction.

In such a conventional optical setup for CTIS, the first optical element is the objective lens 106. Thus, the objective lens 106 acts as an initial field stop, limiting the field of view of the object/scene 102 and first determining the amount of light that reaches the image sensor 104. Light outside the diameter of the objective lens 106 may not be able to travel through the optical system. The aperture 108 may further limit the amount of light that reaches the image sensor 104, acting as a complementary field stop to perform cropping. Alternatively, if the objective lens is removed, then the aperture 108 becomes the initial field stop that limits the field of view of the object/scene 102. In both cases, the aperture 108 may be the optical component that determines the amount of light from the object/scene 102 that reaches the image sensor 104.

The scene 102 may be a static scene or a dynamic scene with motion in a field of view of the apparatus 100A. The scene 102 may be shaped or structured 3-dimensionally. In other words, the scene 102 may comprise a background and one or more objects or structures in a foreground. A light signal from the scene 102 may reflect off one or more objects within a corresponding area of a field stop and then enter the apparatus 100A.

The aperture 108 may be structured in various forms, including as a diaphragm or pinhole, i.e., structures with a hole, which allow light to propagate only through an opening. Outside the opening, there may be a material with a black coating, which absorbs most incident light. The aperture 108 may have various geometrical shapes of the opening, including a circular opening, an optical slit, or a quadratic opening of various widths and lengths. The aperture may let the light signal enter only over a limited area and a limited angular range of the scene. The aperture thus limits a beam angle of the incoming light signal.

Most conventional CTIS apparatuses comprise a diffraction grating as its dispersive element 112. The diffraction grating may be configured to separate the light signal from the scene 202 into multiple diffraction orders, including a zeroth order and higher orders including a first order. The higher orders may exhibit a spectral dispersion of the light signal, or a spatial separation of the spectral components of the light signal. A grating can be manufactured on a flat or concave substrate. A grating may be in the form of a ruled or blazed grating, and it may reflect diffracted light. A grating may be in the form of a holographic grating, and it may transmit diffracted light. The holographic grating may be a volume phase holographic grating (VPHG). The grating may form a material with a change in index of refraction forming an index modulation. The holographic grating may be formed by an interference-fringe field of two or more laser beams, whose standing-wave pattern is exposed to a polished substrate and coated with a photoresist. A holographic image may be computer generated by digitally computing a holographic interference pattern and printing it onto a mask or film for subsequent illumination by a suitable coherent light source. A grating may be configured to achieve maximal optical power in a desired diffraction order, particularly the first diffraction order, while the residual power in other orders may be minimized. This condition may be achieved for a specific range of wavelengths and for a specific range of an angle of incidence of the light signal.

The dispersive element 112 may also comprise a prism. The prism may be a transparent optical element with flat, polished surfaces that are designed to refract light. This may be done by a dispersive medium, through which a phase velocity of different components of the light signal may vary depending on wavelength. At least one surface may be configured at an angle, such that a surface receiving light is not parallel to another surface of the prism. The prism may be made of any material that is transparent to a specific range of wavelengths that may be detected by the image sensor 104. The material of the prism may be glass, acrylic, or fluorite. The prism may be in various known geometries, including in the form of a triangular prism, a compound prism of multiple triangular prisms cemented together such as an Amici prism, a Littrow prism, a Pellin-Broca prism, an Abbe prism, or a Fery prism. The prism may also be in a newly formed geometry that achieves a spatial separation of spectral components of a light signal.

The CTIS apparatus may comprise a collimator 110 placed upstream the dispersive element 112 to collimate the light signal and to aid the generation of properly oriented spectrally dispersed sub-images by the dispersive element 112. The collimator 110 is a device which can reorient a direction of the light signal. To reorient can mean either to cause a direction of the light signal to become more aligned in a specifically chosen direction, or to cause the spatial cross section of the beam to become smaller or larger, particularly if the light signal is diverging or converging, respectively. It may change the direction of the light signal, such that a diverging or converging light signal may be transformed into a beam that is not diverging or converging, respectively. One or more light signals that are not parallel may be transformed into a collection of light signals that are parallel. The collimator 110 may comprise a curved mirror or a curved lens. The collimator 110 may be a fiber collimator, a laser diode collimator, or in the form of a waveguide. The collimator 110 may be of various materials transparent to a desired range of wavelengths.

The CTIS apparatus may comprise a re-imaging lens 114 upstream to the image sensor 104. The re-imaging lens 114 may be configured to image the light signal onto the image sensor 104. Thus, the light signal carrying information corresponding to portions of the scene 102 and whose components may have been diffracted and/or spectrally dispersed may be detected by the image sensor 104. The re-imaging lens 114 may have a focal length, such that the sub-image resolution is large enough for a post-processing or that it meets a requirement of resolution quality.

FIG. 1B shows an adapted conventional design of an optical system for a CTIS apparatus 100B. The apparatus 100B may comprise the same components as apparatus 100A, but without the objective lens 106 as the first optical component to act as a field stop. Contrary to FIG. 1A, the aperture 108 is the first optical element of the CTIS apparatus 100B. The aperture 108 may act as a field stop that limits the field of view of a scene 102 and may be the optical component determining the amount of a light signal to reach the image sensor 104. The apparatus comprises the dispersive element 112 that generates a spectral dispersion of the light signal, the collimating lens 110 to collimate the light signal before it enters dispersive element 112, and the re-imaging lens 114 to image the light signal onto the image sensor 104.

FIG. 1C shows an adapted conventional design of an optical system for a CTIS apparatus 100C. The apparatus may comprise the same components as 100B, wherein the dispersive element 112 may comprise a grism. A grism, also known as a grating prism, is a combination of a grating and a prism arranged so that light at a chosen central wavelength passes without a deviation from an optical path or optical axis. For example, a grism may be designed, such that a green wavelength hits a sensor on the optical axis, whereas the red and blue wavelengths deviate from the optical path. The effects of a beam deviation caused by the grating and by the prism may be canceled for a certain wavelength, since the prism deflects violet light more than red light, while the diffraction grating deflects red light more than violet light.

Using a grism as the dispersive element can help to address the disadvantage of traditional CTIS related to the sub-image size. A traditional dispersive element, such as a diffractive grating, may produce multiple diffraction orders with a very low fill-factor of the detection area on the image sensor 104. Such a configuration unavoidably leads to a very small sub-image. Generating larger sub-images for both the zeroth order and higher orders can improve the resolution for both the spatial and spectral information. A grism, given its ability to spectrally disperse a light signal with a central wavelength maintained on the optical axis, enables a CTIS apparatus to be built, wherein a much larger spectrally dispersed image or sub-image is generated on the image sensor 104and in a location that can be more easily manipulated. It also enables a compact design, wherein the image or sub-image is well-aligned to achieve a maximum usage of the detection area of the image sensor 104. The optical components can generally be arranged in a compact design, wherein the spectrally dispersed image or sub-image is significantly larger compared to images or sub-images produced by a diffractive grating traditionally used in CTIS apparatuses.

FIG. 1D shows a variety of options for the dispersive element 112, particularly in the form of a grism. The grism may comprise a grating, usually blazed, located between two prisms, as depicted in FIG. 1D-(i). The grism may comprise a grating located upstream to the prism, as depicted in FIG. 1D-(ii), or downstream to the prism, as depicted in FIG. 1D-(iii). The grism may comprise multiple gratings, as depicted in FIG. 1D-(iii). The grism may comprise a grating that is united with the prism as part of a single element, particularly in the form of a volume phase holographic grating (VPHG), as previously described. Such an example is depicted in FIG. 1D-(iv).

A grism of a specific design may be advantageous for a specific embodiment of a CTIS apparatus. Either one grism of a specific design may be advantageous as a rotatable element, a grism of one or more specific designs may be advantageous as part of an array of multiple apertures, or a grism of one or more specific designs may be advantageous as part of an array of multiple rotatable elements. Using various combinations of different grism designs may be advantageous in achieving a higher fill-factor of the detection area of the image sensor 104, compared to using a single design of grisms. The grism may be configured to optimize the dispersion for a particular polarization of light or for unpolarized light. The grism may be configured to reduce a distortion, aberration, or misalignment of a generated image, including a smile distortion or rotational distortion. The components of the grism may adopt various geometric forms. The grating itself may also be tilted or even on a freeform surface.

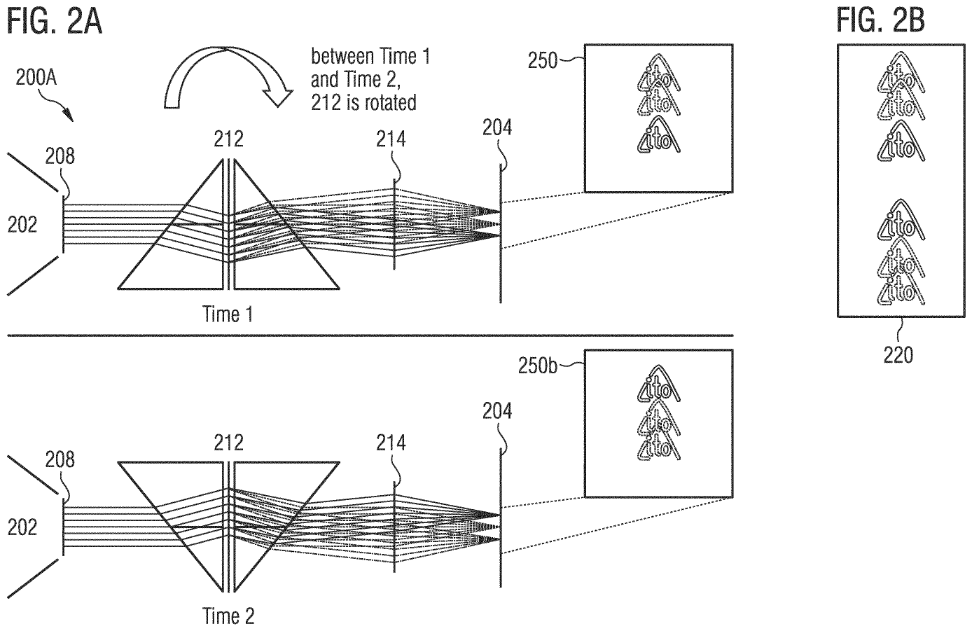

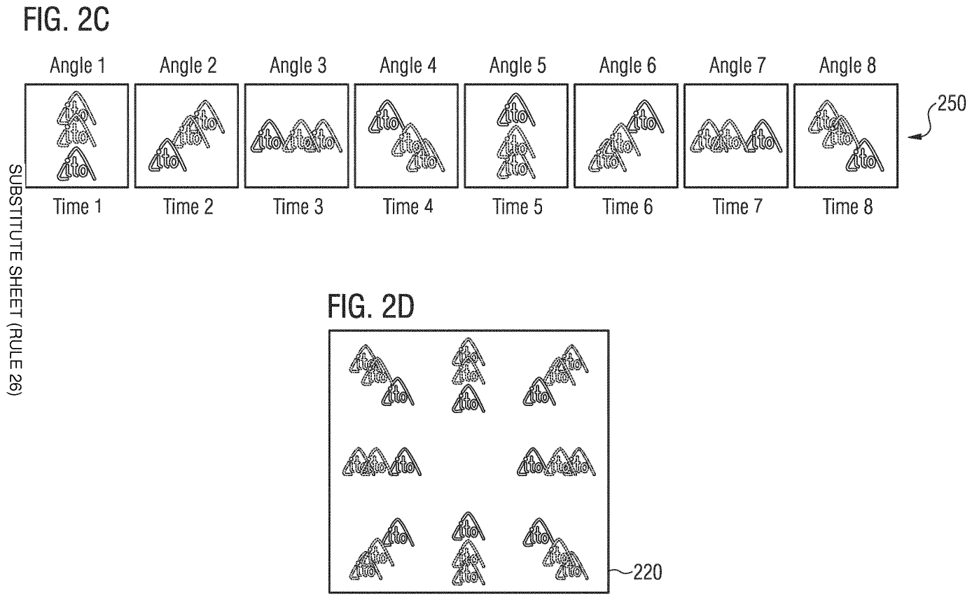

FIG. 2A shows a first embodiment as apparatus 200A. The apparatus 200A comprises an aperture 208, a dispersive element 212, a re-imaging lens 214, and an image sensor 204. The light collected from an area of the scene 202 corresponding to aperture 208 travels through the optical system of apparatus 200A. Light travels through the dispersive element 212 at a first rotation angle, which leads to the generation of a first spectrally dispersed sub-image 250 to be detected by the image sensor 204. The first dispersed sub-image 250 exhibits a spatial separation of the spectral components of the light signal with a first orientation corresponding to the first rotation angle. Spectral components of red, green, and blue wavelengths of the light signal are depicted as being spatially separated by the dispersive element 212. A re-imaging lens 214 may re-orient the light signal, such that the corresponding sub-image is imaged on the image sensor 204. The first sub-image 250 generated by the light signal is detected by the image sensor 204 at a first time. The first sub-image 250 may then converted into an electrical signal to be stored, processed and/or displayed.

The dispersive element 212 may then be rotated to a second rotation angle with all other components remaining fixed. Then light traveling through the dispersive element 112 at a second rotation angle leads to the generation of a second spectrally dispersed sub-image 250b to be detected by the image sensor 204 at a second time. The second spectrally dispersed sub-image 250b exhibits a spatial separation of the spectral components of the light signal with a second orientation corresponding to the second rotation angle. After detection, the second sub-image 250b may then converted into an electrical signal to be stored, processed and/or displayed.

The dispersive element 212 is a rotatable dispersive element and may be a grism, which may offer one or more of the benefits outlined in describing FIGS. 1C and 1D. The axis of rotation may be configured, such that the dispersive element 212 is not moved translationally during rotation but achieves a new angle of entry for a light signal into the material of the dispersive element 212. The CTIS apparatus 200A may further comprise an actuator configured to rotate the dispersive element 212 from a first rotated state to a second rotated state. In such an embodiment, both the first and second sub-images 250 and 250b are spectrally dispersed. The dispersive element may be a grism in order to keep a central wavelength of the light signal on an optical axis of the light signal, enabling the spectrally dispersed sub-images 250 and 250b to make more efficient use of the detection area on the image sensor 204.

A second spectrally dispersed sub-image 250b may offer further useful spectral information of the scene 202, since it is projected into a different direction. In FIG. 2A, the dispersive element 212 at Time 2 is depicted at an inverted orientation, or a second rotation angle at 180°, relative to the dispersive element 212 at Time 1. As a result, the second sub-image 250b is oriented correspondingly to the second rotation angle. The different direction of dispersion by the dispersive element 212 provides different spectral information to be included in a CTIS image 220, which may eventually be used to generate a hyperspectral image. The CTIS image 220 may also be referred to as combined CTIS image 220 as it includes a combination of a plurality of sub-images 250, 250b. The hyperspectral image may be generated without a non-dispersed sub-image.

Since the dispersive element 212 is rotatable, only one aperture 208 corresponding to one entrance to the optical system of apparatus 200A is necessary to provide multiple sub-images 250. In such a configuration, the multiple sub-images 250 are provided corresponding to a single aperture 208 at the cost of an increased time necessary to capture the sub-images 250 in comparison to a traditional CTIS apparatus, such as 100A. Such a configuration offers multiple benefits. For example, the dispersive element 212 may be connected to an actuator, which may be configured to rotate the dispersive element 212 to any desired rotation angle, and thus project the spectral information along any desired direction.

The actuator and its interaction with the dispersive element 212 may come in various example implementations. For example, the actuator may comprise an electric drive/motor. The electric drive/motor may be configured to rotate the dispersive element 212 via a gear or a belt powered by the electric drive/motor. In other embodiments, a rotor of the electric drive/motor may act as a rotation axis of the dispersive element 212. The electric drive/motor may be electronically connected to the image sensor 204, such that the detected sub-image 250, 250b is recorded together with the corresponding rotation angle of the dispersive element 212. The rotation angle can be varied to produce enough sub-images 250 until a desired resolution of a final hyperspectral image is achieved.

FIG. 2B depicts a first embodiment of a combined CTIS image 220 based on the first and second sub-images 250 and 250b. The first and second sub-images 250 and 250b may be individually captured by the image sensor 204 and then processed to form the combined CTIS image 220. Such a combined CTIS image 220 is a minimal version of traditional CTIS images, which may usually generate several more sub-images 250 simultaneously using a diffractive optical element.

FIG. 2C depicts an embodiment of a collection of eight sub-images 250 that the apparatus 200A may be configured to generate. The eight sub-images 250 may each correspond to a specified rotation angle and may be captured at eight separate times. The sub-images 250 may each comprise spectral information that is spatially separated or projected in a different direction corresponding to the specified rotation angle of the dispersive element 212. The rotation angles may each be unique or one or more sub-images 250 may correspond to the same rotation angle. The skilled person having benefit from the present disclosure will appreciate that any number of sub-images 250 corresponding to a specified rotation angle may be captured at a separate time. The sub-images 250 may then be converted to an electrical signal and sent to a processing unit, where they may be combined to a CTIS image 220, which may eventually be used to generate a hyperspectral image.

FIG. 2D depicts a second embodiment of a combined CTIS image 220 based on the eight separately captured sub-images 250 of FIG. 2C. The second embodiment demonstrates how a combined CTIS image 220 is similar to the CTIS image in FIG. 1A after a combination of the sub-images 250 by a processing unit. Such a CTIS image 220 may be generated simultaneously by a traditional CTIS apparatus comprising a diffractive optical element that may generate higher diffraction orders. In apparatus 200A, since each sub-image 250 is detected individually and may occupy much more of the detection area of the image sensor 204, it may be much larger than in traditional CTIS apparatuses, such as 100A. This may greatly improve the resolution of the spectral information captured within each sub-image 250 and may lead to a hyperspectral image corresponding to a 3D data cube of greatly improved resolution.

In such an embodiment, a non-dispersed image is not depicted. While any rotation angle for the dispersive element may be selected, the dispersive element is standing in the optical path between the aperture 208, through which a light signal may enter the system and enter the image sensor 204 downstream.

In a further embodiment not depicted, the dispersive element 212 may be configured with a second rotation mechanism about a second rotational axis. Such a rotation of the dispersive element 212 about the second rotational axis may lead to the dispersive element no longer being located in the optical path between the aperture 208 and the image sensor 204. Such a configuration may also be manipulated by an actuator. In other words, a light signal may enter the optical aperture 208 and then and be detected by the image sensor 204 without having traveled through the dispersive element 212. In such an embodiment, a non-dispersed sub-image may be generated, which may depict more accurate spatial information instead of spectral information. Such a non-dispersed image may also benefit from occupying a larger detection area of the image sensor 204 during detection.

The re-imaging lens 214 may be an anamorphic lens. An anamorphic lens may be structured, such that the focal length of the lens is of a different length in two different predetermined directions. In other words, the anamorphic lens changes the dimensions of an image on a particular axis. For example, image information corresponding to one direction across the diameter of the lens, such as a vertical direction, may be focused on a plane located at a different focal length compared to the plane of focus corresponding to another direction across the diameter of the lens, such as a horizontal direction. An anamorphic lens can generate an image that is compressed along a dimension or an image that is compressed by a different amount along two different directions. Such a lens can distort an image, such that the same image can fit into a smaller area of detection. For example, it may compress the image in the horizontal direction while not compressing it in the vertical direction or compressing the image by a different amount in the horizontal and vertical directions.

The anamorphic lens may also cause the opposite of a compression, or a stretching of an image for certain directions. The installment of one or more anamorphic lens corresponding to one or more apertures 208 may be chosen to improve a fill factor, or to increase the percentage of detection area of the image sensor 204 that is occupied with a light signal originating from the scene 202. By increasing the fill-factor, a processing of the combined CTIS image 220 may be improved. A collimator lens may be placed upstream the dispersive element and may also be an anamorphic lens, which may exhibit some or all of the properties and benefits described above for an anamorphic re-imaging lens.

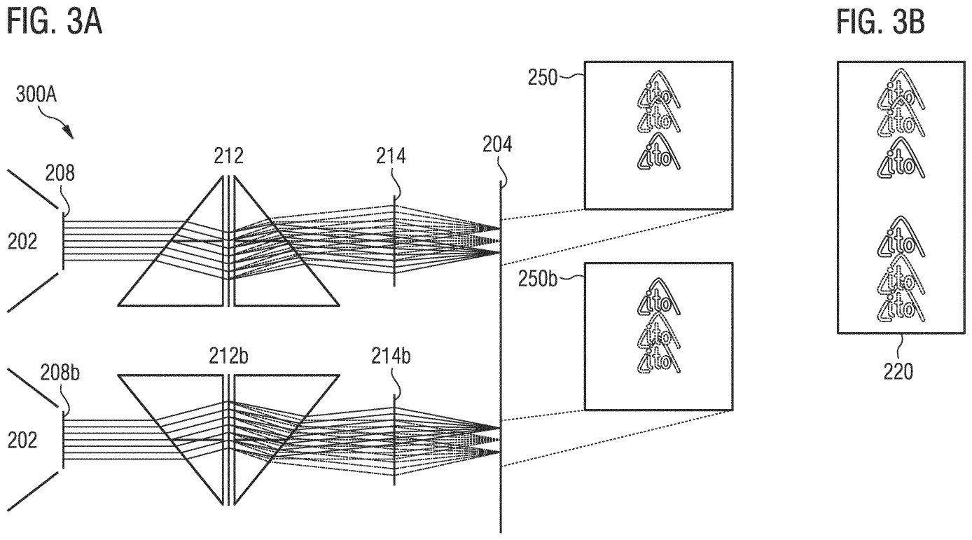

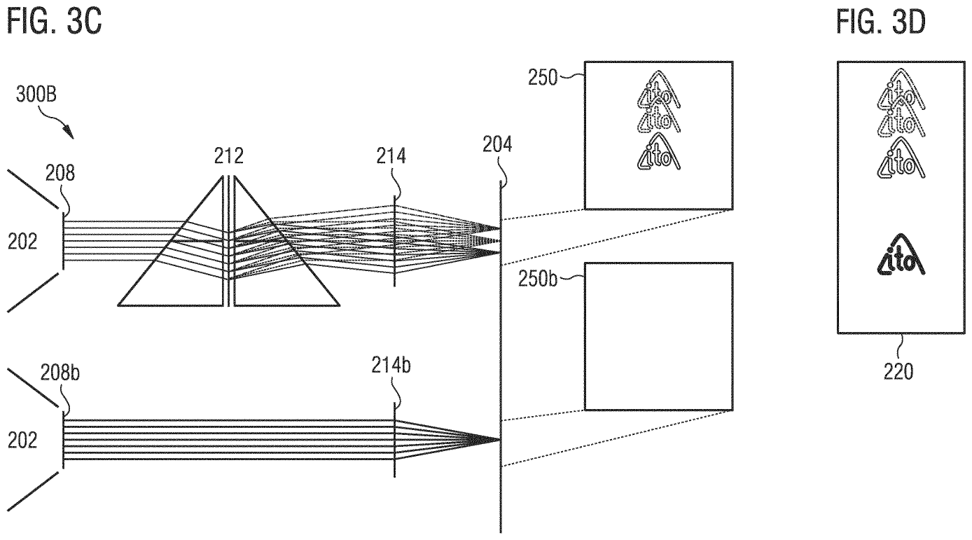

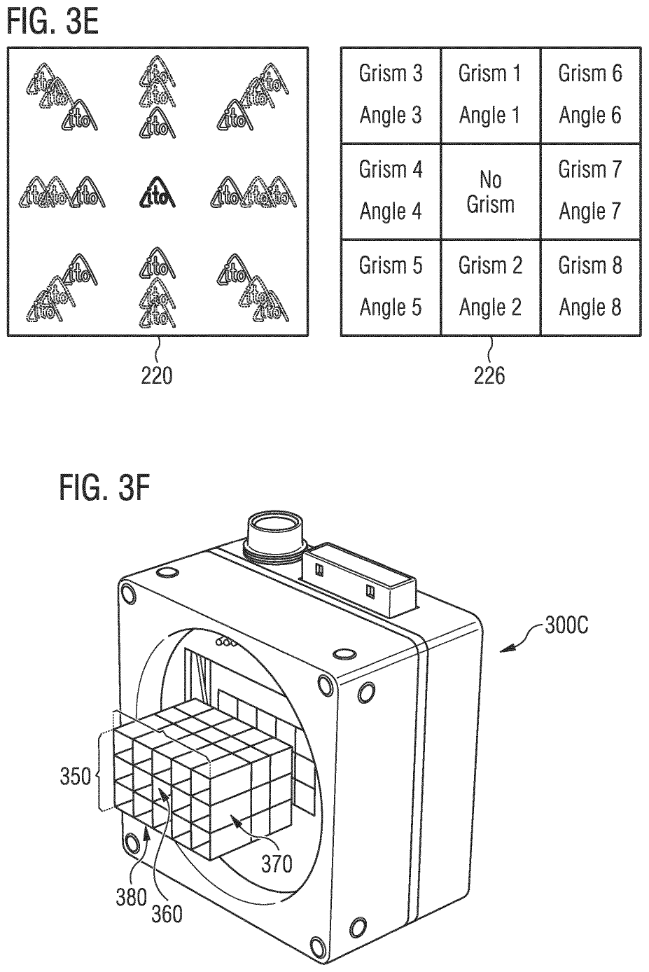

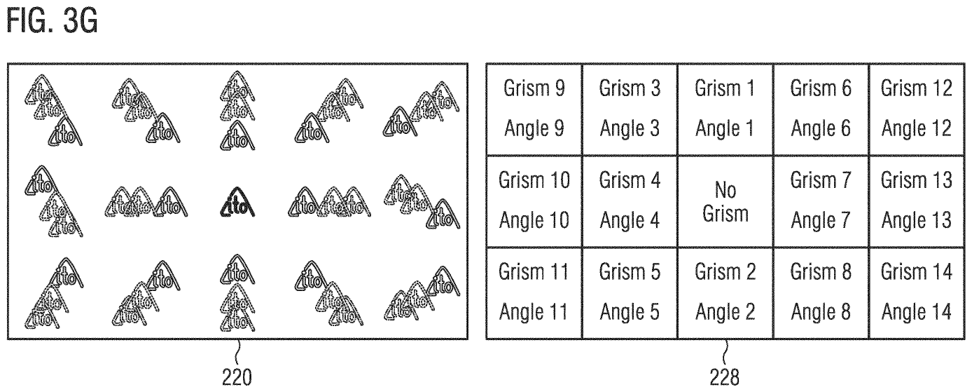

FIG. 3A schematically illustrate a multi-aperture apparatus 300A, comprising two apertures 208 and 208b, each having associated therewith a respective dispersive element, 212 and 212b, and a respective sub-image 250 and 250b. The apparatus 300A comprises a plurality of apertures, which may comprise two or more apertures. A first light signal is collected from a first area of the scene 202 corresponding to aperture 208. Simultaneously, a second light signal is collected from a second area of the scene 202 corresponding to aperture 208b. Apertures 208 and 208b have associated therewith a dispersive element 212 at a first fixed rotation angle and a second dispersive element 212b at a second fixed rotation angle, respectively. The light signals may then travel downstream to the image sensor 204, where they generate spectrally dispersed sub-images 250 and 250b on the image sensor 204, respectively. A respective re-imaging lens 214 and 214b may re-orient the light signals, such that the corresponding sub-image 250, 250b is focused on the image sensor 204. The sub-images may be recorded with the same image sensor 204, as depicted, or with separate image sensors, each corresponding to an aperture 208. The first and second sub-images 250, 250b may then converted into an electrical signal to be stored, processed and/or displayed. As with apparatus 200A, the CTIS image 220 for apparatus 300A may also be referred to as combined CTIS image 220, as it includes a combination of a plurality of sub-images 250, 250b. The sub-images 250 and 250b may instantaneously generate a CTIS image 220 with the use of a single image sensor 204 or the sub-images 250 and 250b may be combined from separate image sensors to form a combined CTIS image 220. This also applies to other embodiments with multiple apertures. FIG. 3A depicting two apertures 208 and 208b is a minimal depiction of such a CTIS apparatus 300A with a plurality of apertures 208.

The first and second areas of the scene 202 may significantly overlap, such that a significant portion of the first area of the scene 202 is equivalent to a significant portion of the second area of the scene 202. In such a configuration, the first and second sub-images 250, 250b may provide different spectral information of an object or scene 202 with an equivalent spatial structure.

FIG. 3B depicts a further embodiment of a combined CTIS image 220 based on the first and second sub-images 250 and 250b for a multi-aperture configuration of the CTIS apparatus 300A. In contrast to apparatus 200A, the image sensor 204 in apparatus 300A may simultaneously capture sub-images 250 and 250b. The sub-images may then be used to form a combined CTIS image 220 at a faster rate compared to apparatus 200A. Such a combined CTIS image 220 with two spectrally dispersed sub-images is a minimal version of traditional CTIS images, which usually generate several more sub-images simultaneously using a diffractive optical element.

FIG. 3C schematically illustrates a multi-aperture apparatus 300B, comprising two apertures 208 and 208b, the first aperture 208 having associated therewith a dispersive element 212 and the second aperture 208 having associated therewith an optical path without a dispersive element. The first aperture 208 has associated therewith a first sub-image 250 that is spectrally dispersed and the second aperture 208b has associated therewith a second sub-image 250b that is non-dispersed. The second sub-image 250b is depicted in FIG. 3C with white light, or a polychromatic light signal with multiple spectral components of light within the visible range that spatially overlap to produce a visibly white light signal. A second sub-image 250b that is non-dispersed may offer useful characteristics of the scene 202, particularly spatial information of the scene 202 without spectral dispersion. It may be used as a spatial reference of an object or scene 202.

FIG. 3D depicts a further embodiment of a combined CTIS image 220 based on the first and second sub-images 250 and 250b for a multi-aperture configuration of the CTIS apparatus 300B. In contrast to apparatus 300A, the image sensor 204 in apparatus 300A may capture sub-images 250 and 250b, wherein sub-image 250 provides spectral information and the sub-image 250b provides accurate spatial information. The sub-images may then be used to form a combined CTIS image 220 at a faster rate compared to apparatus 200. Such a combined CTIS image 220 with one spectrally dispersed sub-image 250 and one non-dispersed sub-image 250b is a minimal version of traditional CTIS images, which may usually generate several more sub-images, including a dispersed image and a non-dispersed image, simultaneously using a diffractive optical element.

FIG. 3E depicts a further embodiment of a combined CTIS image 220 based on nine sub-images corresponding to a CTIS apparatus with nine apertures. A corresponding 3×3 matrix of apertures is also depicted as 226. It depicts an embodiment of a multi-aperture CTIS apparatus comprising nine apertures 208, each of which may or may not have associated therewith a corresponding dispersive element 212. In FIG. 3E, the central aperture is depicted as having no grism or no dispersive element, generating a non-dispersed image in a central location on the image sensor 204 and leading to a non-dispersed image in a central location of the combined CTIS image 220. Such an embodiment may simultaneously capture the multiple sub-images, which may then be used to form the combined CTIS image 220 at a faster rate compared to apparatus 200A.

Such a multi-aperture configuration may also be configured with a rotatable dispersive element corresponding to each aperture, wherein a first combined CTIS image 220 corresponding to one set of rotation angles may be generated corresponding to a first time, one or more dispersive elements may then be rotated, and then a second combined CTIS image 220 corresponding to a second set of rotation angles may be generated corresponding to a subsequent second time. It is also possible to rotate none, some, or all of the rotatable dispersive elements to generate the second combined CTIS image in various permutations of the sub-images 250.

The multiple combined CTIS images can be used together to generate a greater number of sub-images 250 in less time to generate a hyperspectral image of higher quality. Further sub-images may be detected and further combined CTIS images may be generated until sufficient spatial and/or spectral information has been captured to generate a hyperspectral image with a corresponding 3D data cube of accepted quality. The skilled person will appreciate that such an embodiment provides many degrees of freedom to customize how to capture and process light signal information of a scene 202.

A plurality of apertures as part of a multi-aperture design offers multiple benefits compared to conventional CTIS apparatuses. Since each aperture has its own entrance pupil, a higher light throughput can be achieved. As such, imaging and processing with a lower exposure time is possible. This also decreases the requirements for the quality of optical components. Smaller optical components, including smaller lenses, can be implemented, enabling a shorter length for the corresponding optical path.

A greater number of sub-images obtained, particularly at different angles of spectral dispersion, can provide more information to be included in the hyperspectral image. For example, the different locations of the apertures 208 and 208b may also lead to different information of the scene 202 to be captured within the respective aperture. The respective area of the scene 202 of the first aperture 208 may have overlapping or partially overlapping portions to the second aperture 208b.

The plurality of dispersive elements 212 may also be customized to exhibit different properties beyond a rotation angle with respect to each other. The plurality of dispersive elements 212 may vary in their physical characteristics, including size, thickness, geometric form, material, a number of physical layers, or any combination thereof. The dispersive elements 212 may each be configured to transmit a customized range of wavelengths. The range of wavelengths for a dispersive element 212 may be entirely or partially within the visible range or entirely above or below the visible range. The range of wavelengths may also be entirely or partially in the infrared range. Given a plurality of apertures 208 and a plurality of dispersive elements 212, one sub-group of dispersive elements may have different transmission properties according to wavelength compared to one or more other sub-groups of dispersive elements 212. The material of the dispersive element may vary, such that certain ranges of wavelengths may be reflected or absorbed, while other ranges of wavelengths may be transmitted. The properties of the dispersive elements 212 may also be customized to vary the transmission of the light signal based on other properties of the light signal beyond wavelength, such as an intensity or a polarization orientation of the light signal.

Various rotation angles for a dispersive element may be chosen based on a more efficient use of space of the detection area of the image sensor 204. They may also be chosen to improve other factors of the combined CTIS image 220, such as the resolution of certain portions of the combined CTIS image 220 or certain sub-images 250. They may be adapted to the imaging on the image sensor 204 of specific objects or portions of the scene 202, wherein a specific direction of spectral dispersion is favored.

The first aperture 208 may have associated therewith a first re-imaging lens 214 and the second aperture 208b may have associated therewith a second re-imaging lens 214b, wherein the focal length of the first re-imaging lens 214 may be different from the focal length of the second re-imaging lens 214b. Any re-imaging lens 214 may be placed upstream to the image sensor 204 at a specified distance depending on its focal length. With a differently specified focal length of the re-imaging lens 214, a sub-image 250 may be formed at a higher or lower resolution, such that the sub-image 250 forms a larger or smaller percentage of a combined CTIS image 220 within the image sensor 204 in a multi-aperture configuration. This may be useful for performing CTIS of known objects, wherein particular portions or projection directions of a known object or scene 202 need to be projected in greater detail. The re-imaging lens 214 may have a focal length, such that the sub-images 250 are small enough, wherein a first sub-image 250 corresponding to a first aperture 208 does not overlap or significantly overlap with a second sub-image 250b corresponding to a second aperture 208b. The re-imaging lens 214 of one or more apertures 208 may be an anamorphic lens. The multi-aperture apparatuses 300A and 300B can have different types of anamorphic lens to make better use of the detection area of the image sensor 204.

FIG. 3F shows a further embodiment 300C of a multi-aperture CTIS apparatus. The plurality of apertures 208 may comprise M×N apertures arranged in an M×N matrix, comprising N columns and M rows of apertures. In FIG. 3F, the M×N matrix of apertures 350 is depicted as a 3×5 matrix corresponding to 5 columns and 3 rows of apertures, but it may be any number of rows and columns. A light signal may enter the M×N matrix of apertures 350, wherein each aperture 208 may or may have associated therewith a dispersive element 212. One or more apertures 208 may be dedicated to generating a non-dispersed sub-image, such as 250b in apparatus 300B, depicted as 360 in apparatus 300C. This aperture may be centrally located or located elsewhere in the array.

The M×N matrix of apertures 350 may comprise a respective field stop 370 for each aperture 208. The physical structure of the field stop 370 may determine the field of view of the aperture 208. This may lead to a tradeoff of providing greater focus on a specific object in a scene 202 at the cost of a smaller field of view. The physical dimensions or form of the field stop 370 may vary within the same M×N matrix of apertures 350. The field stop 370 may comprise a field stop boundary 380 that is shared by more than one aperture 208, as depicted in apparatus 300C. A field stop boundary 380 of a first aperture 208 may be in contact with a field stop boundary 380 of a second aperture 208b or be isolated from other apertures 208. The field stop boundaries 380 may be in a quadratic form, in a circular form, or in another geometric form.

The optical axes of each of the plurality of apertures 208 may be parallel to each other. Such an embodiment is depicted in FIG. 3F, wherein the optical axes of each of the apertures 208 are parallel. The generated CTIS image on the image sensor 204 may comprise multiple sub-images 250 of a scene 202, which may or may not have overlapping information of the scene 202 within multiple sub-images 250. For example, portions of the scene 202 forming the first sub-image 250 corresponding to the first aperture 208 may be the same portions of the scene 202 forming a second sub-image 250b corresponding to the second aperture 208b.

The optical axes of a first subset of the plurality of apertures 208 may be oriented in different directions than the optical axes of a second subset of the plurality of apertures 208. For example, the multiple optical axes may be oriented, such that the multiple optical axes are perpendicular to a theoretical surface with the form of a sphere or a similarly round figure. In such an embodiment, the generated sub-images 250 may have a reduced overlapping or no overlapping of information of a scene 202. A first sub-image 250 corresponding to a first aperture 208 may comprise completely different information of a light signal of the scene 202 compared to a second sub-image 250b corresponding to a second aperture 208b, since the optical axes corresponding to each aperture may be oriented in different directions. This may increase the overall field of view of the CTIS apparatus 300C. In such an example, information of a light signal corresponding to a greater field of view of the scene 202 is able to fit into the same detection area of the image sensor 204 and can be simultaneously captured.

FIG. 3G depicts an embodiment of a combined CTIS image 220 that may be generated by apparatus 300C. A sub-image 250 for each aperture 208 may be generated downstream the corresponding dispersive element 212 on the image sensor 204, providing Mx N sub-images 250 in an M×N matrix corresponding to the M×N matrix of apertures 350. In FIG. 3G, the sub-images 250 are arranged in a rectangular 3×5 matrix, depicted as 228, corresponding to the same orientation of the M×N matrix apertures 350 in apparatus 300C. The image sensor 204 may simultaneously capture the sub-images 250 for time-efficient processing.

Since a dispersive element 212 may be customized to be positioned at any rotation angle, the orientation of each sub-image 250 within the generated CTIS image may also be customized accordingly. The M×N matrix of apertures 350 may be arranged for a more efficient use of the detection area of the image sensor 204. Such arrangements may change depending on the object or scene 202 to be imaged or depending on a desired construction of the CTIS apparatus 300C.

An aperture 208 configured without a dispersive element 212 may be located within a central aperture of the M×N matrix of apertures 360, as shown in FIG. 3F, such that a non-dispersed sub-image 250 is located in a central location of the generated CTIS image 220, as shown in FIG. 3G. It may alternatively be located in another aperture 208. It is also possible for two or more apertures 208 to not have associated therewith a dispersive element 212. The non-dispersed sub-image 250 may form an image that corresponds to the shape or form of an object in the scene 202 and may accordingly provide spatial information of the object or scene 202. The non-dispersed sub-image 250 may form a reference image or a basis of comparison for the dispersed sub-images 250.

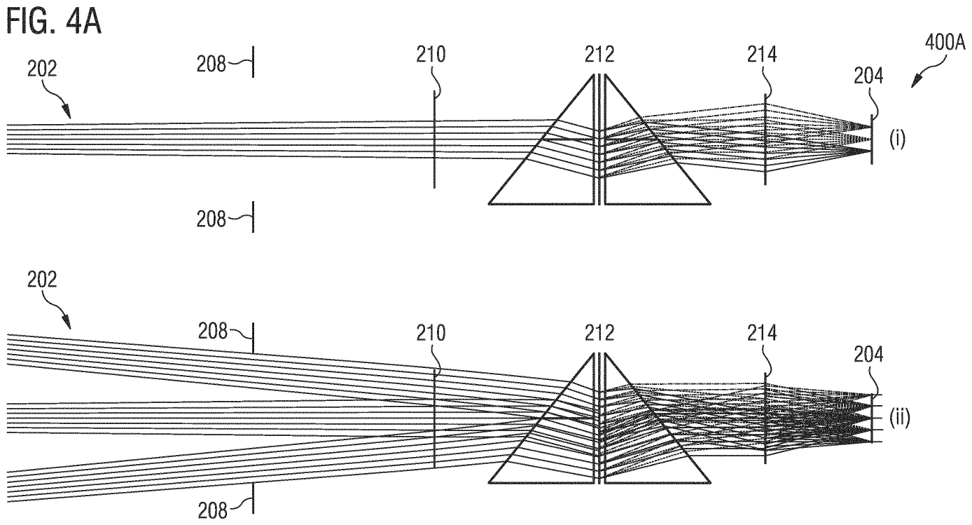

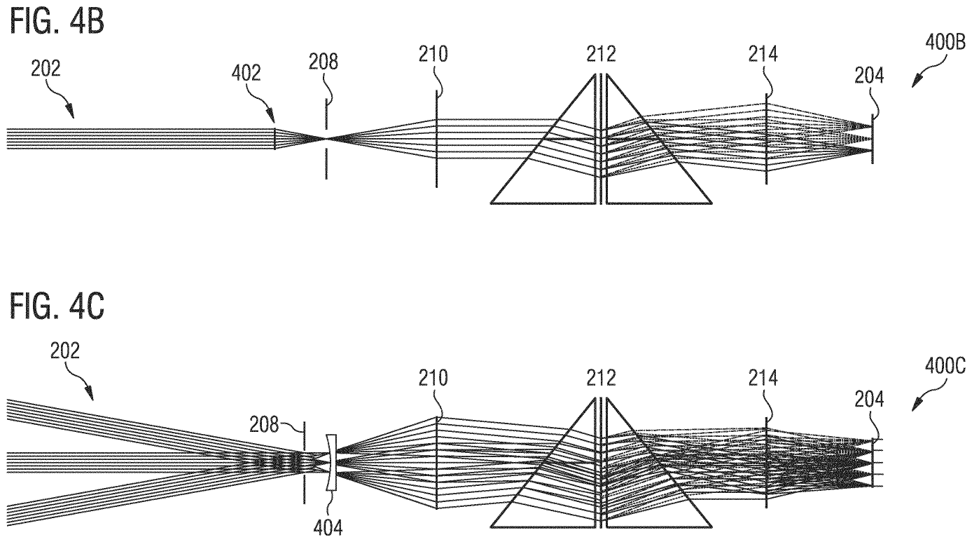

FIG. 4A is a configuration of a CTIS apparatus equivalent to the CTIS diagram of FIG. 1C, depicting a CTIS apparatus 400A comprising an aperture 208 configured as a field stop, a collimator 210, a dispersive element 212, depicted as a grism, a re-imaging lens 214, and an image sensor 204.

FIG. 4B depicts a CTIS apparatus 400B, which is a Keplerian design of apparatus 400A. The Keplerian design comprises an objective lens 402 as the first optical element of the apparatus, forming an intermediate image upstream to the dispersive element 212. Also upstream the dispersive element 212 is an aperture 208 that can act as a field stop to crop the image, enabling the user to customize how much of the area of detection on the image sensor 204 the image will occupy. Such a configuration can also increase the field of view for the respective aperture 208, depending on the focal lengths of the objective lens 402, collimator 210, reimaging lens 214, and the diameter of aperture 208. The apparatuses 200A, 300A, 300B, and 300C configured with a Keplerian design may be configured with an increased field of view within each aperture 208. In a multi-aperture configuration, one or more apertures may have associated therewith an objective lens 402, making use of one or more of the described benefits.

FIG. 4C depicts a CTIS apparatus 400C, which is a Galilean design of apparatus 400A. The apparatus 400C comprises an aperture 208 acting as a field stop as the first optical element of the CTIS apparatus 400C. Downstream to the aperture 208, the CTIS apparatus 400C comprises a beam expander 404. The beam expander 404 may correspond to an inverted Galilean telescope. The beam expander 404 (inverted telescope) can reduce the incoming beam angles and thus also the total focal length. It also increases the beam diameter. The main function of the beam expander 404 is to keep the ray angles at the grating low together with a high field of view (high ray angles). While a Keplerian design forms an intermediate image that may be cropped to customize the generated CTIS image 220, an apparatus of a Galilean design does not form an intermediate image. In a multi-aperture configuration, one or more apertures may have associated therewith a beam expander 404, making use of one or more of the described benefits.

The CTIS apparatus may further comprise an image processor configured to compute a hyperspectral image of the scene based on the first and second sub-images. The CTIS apparatuses may also comprise an image processing circuit configured to compute a hyperspectral image of the scene. The image processing circuit may comprise one or more processors configured to perform EM or MART, for example. However, the aforementioned conventional iterative reconstruction algorithms (EM, MART) are usually computationally very intensive.

The present disclosure summarizes a lightweight network architecture to efficiently reconstruct spatially super-resolved hyperspectral cubes from 2D measurements generated by a CTIS system, owing to its high spectral resolution and the availability of multiple tomographic projections, each carrying distinct spatial and spectral information needed to reconstruct the latent 3D hyperspectral cube.

The present disclosure also proposes a novel reconstruction algorithm for the scene's hyperspectral image (3D data cube) based on a neural network. The CTIS apparatuses may include an artificial neural network processor configured to compute a hyperspectral image (3D data cube) of the scene based on the CTIS image. The skilled person having benefit from the present disclosure will appreciate that the proposed artificial neural network processor is independent of the proposed optical setup of FIGS. 2 through 7 and may also be combined with conventional optical setups of CTIS, such as shown in FIG. 1. As such, the post-processing may adapt to varying fill-factors of different optical setups in the CTIS apparatus.

The artificial neural network may be configured to learn in an end-to-end fashion and then execute a learned filtered back-projection (LBP) algorithm based on traditional computer tomography scans. Back-projection is a standard method of reconstructing an image based on multiple tomographic projections stretched from a frame along various directions, wherein the projections along the various directions are compressed back into the original frame. Back-projection usually produces a smeared or blurry image with halo-like effects and with a low signal-to-noise ratio in comparison to a standard image, which does not have any supplemental information from such projections along multiple directions. In order to decrease the smearing or blurriness, a filtering mechanism can be applied before compressing the projections to the original frame in back-projection. This may be in the form of a high-pass Ramp filter or a sharpening filter. By filtering information corresponding to lower frequencies, the less useful information that overlaps the pixel can be discarded and a higher contrast of the image can be obtained. Thus, through filtered back-projection, a reconstructed image with greater spectral information can be obtained, which may also enable objects to be distinguished with a higher-quality contrast and less noise.

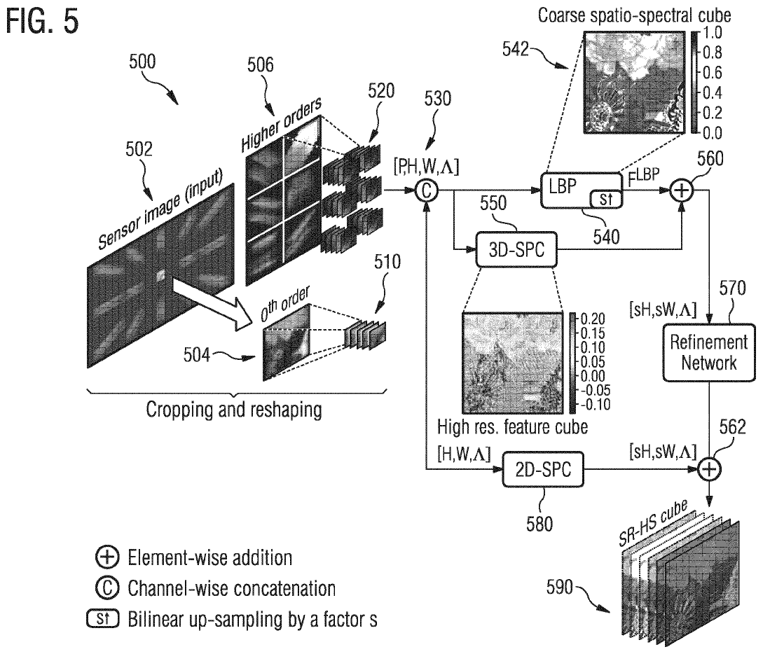

FIG. 5 schematically illustrates a neural network architecture 500 for the production of a super-resolution hyperspectral (SR-HS) cube from an input of CTIS measurements based on the present disclosure.

A sensor image 502 is similar to the CTIS image 220 shown in FIG. 3G. Either may be used as input of CTIS measurements to the neural network, providing a central sub-image projection 504 equivalent to a zeroth order projection and dispersed image projections 506, equivalent to higher orders of a diffraction grating. In the case of the present disclosure, the central sub-image projection 504 may be equivalent to a sub-image 250 generated from an optical path without a dispersive element 212, and the dispersed image projections 506 may be equivalent to dispersed sub-images 250 generated by optical paths with a dispersive element 212. While anon-dispersed sub-image 250 is usually centrally located in conventional CTIS setups, it may be located anywhere on the image sensor 204 in the case of the present disclosure. There may be a total number of P projections including the central sub-image projection 504, wherein each projection is divided to a number of Λ spectral bands that are cropped and reshaped to a collection of frames. The frames of the zeroth order projection 510 and frames of the dispersed image projections 520 are grouped separately. The frames may have dimensions H×W, which may describe the number of pixels of each frame.

An image processor may be configured to perform a traditional filtered back-projection operation, which can be described as mapping low dimensional 2D projections into the higher dimensional 3D hyperspectral space. The 3D hyperspectral image may comprise a number of P projections, each of which may correspond to a sub-image within the sensor image 502. In the case of the present disclosure, they may be generated from an optical path with a dispersive element 212 at a respective rotation angle or without a dispersive element 212. Each projection may be divided into a number of Λ spectral bands, whose number may be chosen based on a speed vs. accuracy tradeoff. Thus, the 3D hyperspectral image may be regarded to comprise a number of P×Λ (2D) sub-images (in FIGS. 5, 510 and 520 together), which may each have dimensions H×W.

The Λ spectral bands may be combined or back-projected to a hyperspectral 3D sub-image (3D data cube) of each of the P projections, which may include forming a 3D sub-image from the frames 510 of the central sub-image 504 and from the frames 520 corresponding to sub-images 506. The image processor may comprise one or more reshaping layers configured to combine different spectral bands of a 2D sub-image that belong together in a spatial dimension of the 3D hyperspectral image. The spatial dimensions of the different spectral bands may be identical and may correspond to the non-dispersed sub-image. The one or more reshaping layers of the image processor may be configured to stack Λ 2D sub-images of the scene 202 corresponding to Λ different spectral bands, for each of the P projections in order to form P hyperspectral sub-images (3D data cubes).

The image processor may also perform a summation for each of the Λ spectral bands across the P projections, forming 2D sub-images of dimensions H×W, each with information from each of the P projections. Each 2D sub-image may then correspond to a spectral channel. Altogether, there may be Λ spectral channels, and the Λ spectral channels may be stacked or concatenated channel-wise, labeled 530 in within the neural network architecture 500. In a filtered back-projection, the P projections may first be filtered by a high pass Ramp filter. Mathematically, this may be equivalent to summing the spectral channel across the projections with a weight or kernel, corresponding to a frequency or contrast within the sub-image. This may produce a rendition of the 3D hyperspectral cube of dimensions H×W×Λ, a coarse spatio-spectral cube 542.

In another embodiment of the present disclosure, each of the Λ spectral bands or channels may undergo a learned back-projection (LBP) operation F^{LBP} 540, inspired by traditional filtered back-projection models. This may also produce a coarse spatio-spectral cube 542, and may be achieved by means of one or more 3D deconvolution layers.

The filtered back-projection introduces high-frequency noise and ringing artifacts due to the structure of such a filter. Furthermore, although the back-projection evenly maps 2D projected data back into hyperspectral space through the summation, it does not take into account the different contributions of each projection, i.e., the fact that the amount of dispersion differs for each projection. Learned back-projection enables learning more complex non-linear relationships among CTIS projections, but also within each projection. In particular, intra-projection correlations can be learned by means of the 3D deconvolution layer.

The number of projections is finite, providing limited aliased information and further motivating the use of deep-learning based approaches. In particular, 3D deconvolutions can be used to link spatial information scattered across multiple projections to learn more complex features. Since convolutions are carried out in a low resolution space, such an approach is very efficient, yet it also achieves competitive image restoration results.

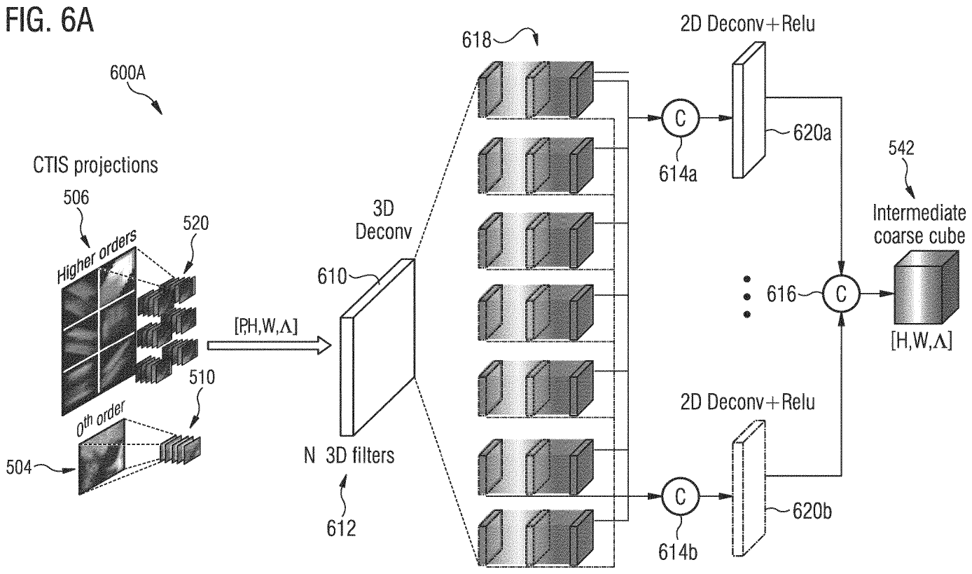

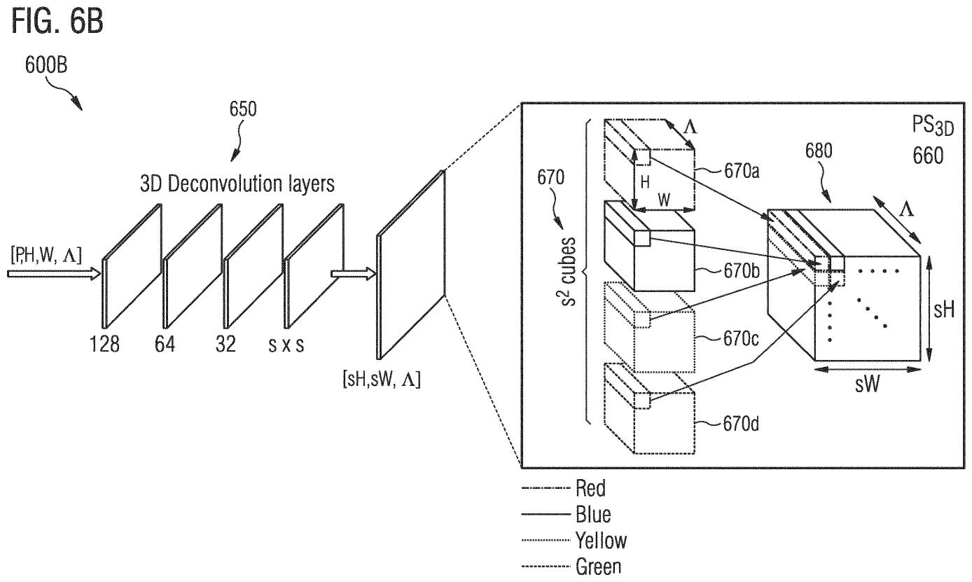

FIG. 6A schematically illustrates the architecture of the learned back-projection (LBP) operation 540 from FIG. 5 in greater detail. Each of the P×Λ (2D) sub-images 520, which may each have dimensions H×W, may be sent to the one or more 3D deconvolution layers 610. Instead of summing across the P channels as in traditional back-projection, the 3D deconvolution layers may apply a number N 3D filters 612, which may produce a collection of feature maps 618 of Λ×H×W dimensions and N channels. A 2D deconvolution layer and one or more Rectified Linear Unit (ReLU) activation function may be applied to the Λ spectral bands. A ReLU activation function is a piecewise linear function responsible for transforming a summed weighted input from a node into an output.

The feature maps, which may carry distinct spatial and spectral information of the same spectral band, may be concatenated channel-wise, as indicated by 614a and 614b, to a sub-channel for each of the Λ spectral bands. For each spectral band, a sub-channel may be generated, such as 620a for a blue spectral band and 620b for a red spectral band, along with other spectral bands in between represented by the three vertical dots. Finally, the Λ output bands may be concatenated channel-wise 616, producing a coarse spatio-spectral version of the hyperspectral cube 542 of Λ×H×W dimensions.

The artificial neural network may also comprise a hyperspectral image super-resolution module 550, which may exploit side information present in various projections through 3D deconvolution layers. The super-resolution module 550 may be a 3D Sub-Pixel Convolution (3D-SPC) module 550, wherein the 3D-SPC module 550 performs a 3D sub-pixel convolution. Such a neural network can combine hyperspectral image reconstruction and super-resolution for CTIS systems. As such, the coarse spatio-spectral cube 542 may be added in an element-wise fashion 560 to a high-resolution feature cube 552 generated by a 3D sub-pixel convolution operation by the 3D-SPC module 550.

Each dispersive element 212 of the CTIS apparatuses in the previous figures may generate a light signal, leading to a projection that may include information in the form of a local point spread function. Such information may differ slightly between each projection and for each wavelength, which may lead to a sub-pixel shift. 3D sub-pixel convolution may detect sub-pixel shifts between different frames. This may particularly be the case across image edges, whereby the smearing direction for each projection preserves image gradients along that same direction, e.g., vertical edges are preserved in vertical projections, and so on. Such observations can be exploited in a residual learning context of the 3D -SPC module 550 through application of a set of 3D deconvolution layers. It may restore high resolution image features, i.e., high spatial frequencies that are summed up with the coarse spatio-spectral cube generated by learned back-projection.

The 3D-SPC operation may also enable a distinguishing of certain features, which otherwise cannot be distinguished. For example, each projection also contains aliasing, a well-known side effect of downsampling, causing high-frequency components of an original signal to become indistinguishable from its low-frequency components. Aliasing also provides distinct spatial information needed to construct a spatially super-resolved hyperspectral image.

FIG. 6B schematically illustrates the 3D-SPC module 550, which may comprise a collection of 3D deconvolution layers 650, and which may be configured to perform a 3D-SPC operation. As in the LBP operation 940, input data of dimensions of P channels, Λ spectral bands, and frames of H×W may be sent to the 3D-SPC module 550. The collection of 3D deconvolution layers 650 may comprise layers of 128, 64, 32, and s×s output channels, which are to be applied in such an order to perform the 3D-SPC operation. Applying the 3D-SPC operation to the collection of projections (510 and 520) may generate a 4D feature map with dimensions of s² channels, Λ spectral bands, and H×W pixels.

A new 3D Pixel Shift (PS3D) operation 660 may be applied on the feature map for each spectral band within Λ. This can exploit side spatial information to perform super-resolution via 3D periodic shuffling. The final 3D deconvolution layer 650, which may have s×s dimensions, may generate an output of a number of s×s cubes 670a to 670d, each cube with dimensions H×W×Λ. Cubes 670a to 670d are labeled for different spectral channels. With each cube including frame dimensions H×W, the overall output 680 may have dimensions sH×sW blocks and Λ spectral bands.

The 3D-SPC operation may be used to link spatial information scattered across multiple projections and to learn more complex features. Such a procedure may be described as an adaptation of ESPNC, efficient sub-pixel convolutional neural networks, usually applied to a single image for super-resolution. Since the convolutions are carried out in low resolution space, such an approach is very efficient, yet it achieves competitive image restoration results.

This output of dimensions sH×sW×Λ may be sent to a Refinement Network 570, shown in FIG. 5, which may comprise one or more convolution layers, each of which may comprise one or more filters, wherein one or more Rectified Linear Unit (ReLU) activation functions are applied. The output may be summed up with a super-resolved zeroth order using a 2D-SPC layer 580, which may result in a super-resolution hyperspectral (SR-HS) cube 590.

Such a neural network, together with a CTIS apparatus as described in the figures, can obtain and organize large amounts of information in significantly less processing time and with greater resolution. There are various applications, for which the present disclosure could be used. These include images for automotive software, including support of object detection, lane detection, and analysis of wet or icy road conditions, beauty care, including a skin analysis to support the selection of the most suitable skin care product, medical applications, including skin cancer diagnosis, and recycling, including material discrimination for sorting, such as plastics.

The skilled person will appreciate that there are many possible configurations of the CTIS apparatus, each of which provide multiple sub-images containing spatial and spectral information to be processed.

One such CTIS apparatus comprises a plurality of apertures configured to limit a respective area of a scene over which light is collected, wherein a first of the plurality of apertures has associated therewith a dispersive element configured to generate a first sub-image of the scene that is dispersed, and wherein a second of the plurality of apertures has associated therewith a second sub-image of the scene. Downstream to the plurality of apertures and the at least one dispersive element, an image sensor configured to detect a CTIS image comprising the first and second sub-images. The second aperture may be configured without a dispersive element, such that the second sub-image is a non-dispersed image, or it may have associated therewith a second dispersive element, such that the second sub-image is also a spectrally dispersed.

Another such CTIS apparatus comprises a rotatable dispersive element, an actuator configured to rotate the dispersive element from a first rotation state to a second rotation state, wherein the first rotation state has associated therewith a first dispersed image and the second rotation state has associated therewith a second dispersed image. Downstream to the dispersive element, an image sensor is configured to capture the first dispersed image at a first time and to capture the second dispersed image at a subsequent second time.

These two configurations may be combined, such that the CTIS apparatus comprises a plurality of apertures, one or more apertures having associated therewith a rotatable dispersive element. The skilled person will appreciate that the various embodiments of the CTIS apparatus and the post-processing scheme provides many benefits, including an ability to better customize hyperspectral images according to a desired quality or processing time. The embodiments may be customized depending on an object or scene 202 to be imaged or the range of wavelengths to be transmitted. Each apparatus may itself vary in flexibility of configuration, such as comprising one or more rotatable grisms, or comprising varied sizes or qualities in optical components. With the option to combine the flexibility in the construction of the CTIS apparatus to new post-processing schemes, the quality of hyperspectral images may be increased and the procedure of detection better adapted to specific user needs.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

Note that the present technology can also be configured as described below.

Example 1 is a CTIS apparatus comprising at least one dispersive element at a first rotated state to generate a first sub-image of a scene, wherein the first sub-image is a dispersed image, and downstream to the dispersive element, an image sensor configured to detect a CTIS image comprising the first sub-image that is dispersed and a second sub-image, wherein the CTIS apparatus is configured to generate the first sub-image for a first rotated state of the dispersive element, and generate the second sub-image for a second rotated state of the dispersive element, for another dispersive element, or for no dispersive element.

In Example 2, the CTIS apparatus of Example 1 comprises a first aperture configured to limit an area of the scene over which light is collected, wherein the first aperture has associated therewith the dispersive element and the first sub-image.

In Example 3, the CTIS apparatus of Example 2 further comprises at least a second aperture having associated therewith the second sub-image, wherein the first and the second apertures form a plurality of apertures.

In Example 4, the CTIS apparatus of Example 3 is configured without a dispersive element and the second sub-image of Example 3 is a non-dispersed image.

In Example 5, the second aperture of Example 3 has associated therewith a second dispersive element.

In Example 6, the CTIS apparatus of Example 3 is configured, such that the first aperture has associated therewith a first re-imaging lens and the second aperture has associated therewith a second re-imaging lens, wherein the focal length of the first re-imaging lens is different from the focal length of the second re-imaging lens.

In Example 7, the CTIS apparatus of Example 5 is configured, such that the first dispersive element is configured to transmit a different range of wavelengths compared to the second dispersive element.

In Example 8, the CTIS apparatus of Example 5 is configured, such that the second dispersive element associated with the second aperture is arranged in a differently rotated state relative to the dispersive element associated with the first aperture.

In Example 9, the first and second apertures of Example 5 each comprises a respective optical axis, wherein the dispersive element associated with the first aperture is arranged rotated about its optical axis by a first angle and the second dispersive element associated with the second aperture is arranged rotated about its optical axis by a second angle different from the first angle.

In Example 10, the plurality of apertures of Example 3 comprises M×N apertures arranged in an M×N matrix, comprising N columns and M rows of apertures.

In Example 11, the first and second optical axes of Example 9 are parallel to each other.

In Example 12, the first and second optical axes of Example 9 are oriented in different directions.

In Example 13, the CTIS apparatus of Example 1 is configured, wherein the dispersive element is a rotatable dispersive element, and wherein the CTIS apparatus further comprises an actuator configured to rotate the dispersive element from the first rotated state to the second rotated state, and wherein the image sensor is configured to capture the first sub-image at the first rotated state at a first time and to capture the second sub-image at the second rotated state at a subsequent second time, and wherein both the first and second sub-images are dispersed.

In Example 14, the dispersive element of any one of the previous Examples comprises a grism.

In Example 15, the CTIS apparatus of any one of the previous Examples further comprises a field stop upstream to the dispersive element.

In Example 16, the CTIS apparatus of any one of the previous Examples further comprises a collimator upstream to the dispersive element, configured to collimate light from the scene.

In Example 17, the CTIS apparatus of any one of the previous Examples further comprises a re-imaging lens upstream to the image sensor.

In Example 18, the re-imaging lens of Example 17 is an anamorphic lens.

In Example 19, the CTIS apparatus of any one of the previous Examples further comprises an image processor configured to compute a hyperspectral image of the scene based on the first and second sub-images.

Example 20 is a CTIS apparatus comprising a plurality of apertures configured to limit a respective area of a scene over which light is collected, wherein a first of the plurality of apertures has associated therewith a dispersive element configured to generate a first sub-image of the scene that is dispersed, and wherein a second of the plurality of apertures has associated therewith a second sub-image of the scene, and downstream to the plurality of apertures and the at least one dispersive element, an image sensor configured to detect a CTIS image comprising the first and second sub-images.

In Example 21, the second aperture of Example 20 is configured without a dispersive element and the second sub-image of Example 20 is a non-dispersed image.

In Example 22, the second aperture of Example 20 has associated therewith a second dispersive element.

Example 23 is a CTIS apparatus comprising a rotatable dispersive element, an actuator configured to rotate the dispersive element from a first rotation state to a second rotation state, wherein the first rotation state has associated therewith a first dispersed image and the second rotation state has associated therewith a second dispersed image; and comprising downstream to the dispersive element, an image sensor configured to capture the first dispersed image at a first time and to capture the second dispersed image at a subsequent second time.

Example 24 is a method for CTIS, the method comprising generating a first dispersed sub-image of a scene with at least one dispersive element at a first rotated state and generating a second sub-image of the scene for a second rotated state of the dispersive element, for another dispersive element, or for no dispersive element, and further comprising detecting a CTIS image comprising the first dispersed sub-image and the second sub-image.

Example 25 is a method for CTIS, the method comprising providing a plurality of apertures configured to limit a respective area of a scene over which light is collected, wherein a first of the plurality of apertures has associated therewith a dispersive element configured to generate a first sub-image of the scene that is dispersed, and wherein a second of the plurality of apertures has associated therewith a second sub-image of the scene, and further comprising detecting a CTIS image comprising the first and second sub-images with an image sensor downstream to the plurality of apertures and the at least one dispersive element.

Example 26 is a method for CTIS, the method comprising rotating a dispersive element from a first rotation state to a second rotation state, wherein the first rotation state of the rotatable dispersive element leads to a first dispersed image of a scene and the second rotation state leads to a second dispersed image of the scene, and further comprising capturing the first dispersed image at a first time and capturing the second dispersed image at a subsequent second time.

1. A CTIS apparatus, comprising
at least one dispersive element at a first rotated state to generate a first sub-image of a scene, wherein the first sub-image is a dispersed image, and
downstream to the dispersive element, an image sensor configured to detect a CTIS image comprising the first sub-image that is dispersed and a second sub-image,
wherein the CTIS apparatus is configured to
generate the first sub-image for a first rotated state of the dispersive element, and
generate the second sub-image for a second rotated state of the dispersive element, for another dispersive element, or for no dispersive element.

2. The CTIS apparatus of claim 1, comprising a first aperture configured to limit an area of the scene over which light is collected, wherein the first aperture has associated therewith the dispersive element and the first sub-image.

3. The CTIS apparatus of claim 2, further comprising at least a second aperture having associated therewith the second sub-image, wherein the first and the second apertures form a plurality of apertures.

4. The CTIS apparatus of claim 3, wherein the second aperture is configured without a dispersive element and the second sub-image is a non-dispersed image.

5. The CTIS apparatus of claim 3, wherein the second aperture has associated therewith a second dispersive element.

6. The CTIS apparatus of claims 3, wherein the first aperture has associated therewith a first re-imaging lens and the second aperture has associated therewith a second re-imaging lens, wherein the focal length of the first re-imaging lens is different from the focal length of the second re-imaging lens.

7. The CTIS apparatus of claim 5, wherein the first dispersive element is configured to transmit a different range of wavelengths compared to the second dispersive element.

8. The CTIS apparatus of claim 5, wherein the second dispersive element associated with the second aperture is arranged in a differently rotated state relative to the dispersive element associated with the first aperture.

9. The CTIS apparatus of claim 5, wherein the first and second apertures each comprises a respective optical axis, wherein the dispersive element associated with the first aperture is arranged rotated about its optical axis by a first angle and the second dispersive element associated with the second aperture is arranged rotated about its optical axis by a second angle different from the first angle.

10. The CTIS apparatus of claim 3, wherein the plurality of apertures comprise M×N apertures arranged in an M×N matrix, comprising N columns and M rows of apertures.

11. The CTIS apparatus of claim 9, wherein the first and second optical axes are parallel to each other.

12. The CTIS apparatus of claim 9, wherein the first and second optical axes are oriented in different directions.

13. The CTIS apparatus of claim 1,
wherein the dispersive element is a rotatable dispersive element; and
wherein the CTIS apparatus further comprises an actuator configured to rotate the dispersive element from the first rotated state to the second rotated state; and
wherein the image sensor is configured to capture the first sub-image at the first rotated state at a first time and to capture the second sub-image at the second rotated state at a subsequent second time; and
wherein both the first and second sub-images are dispersed.

14. The CTIS apparatus of claim 1, wherein the dispersive element comprises a grism.

15. The CTIS apparatus of claim 1, further comprising a field stop upstream to the dispersive element.

16. The CTIS apparatus of claim 1, further comprising a collimator upstream to the dispersive element, configured to collimate light from the scene.

17. The CTIS apparatus of claim 1, further comprising a re-imaging lens upstream to the image sensor.

18. The CTIS apparatus of claim 17, wherein the re-imaging lens is an anamorphic lens.

19. The CTIS apparatus of claim 1, further comprising an image processor configured to compute a hyperspectral image of the scene based on the first and second sub-images.

20. A CTIS apparatus, comprising
a plurality of apertures configured to limit a respective area of a scene over which light is collected,
wherein a first of the plurality of apertures has associated therewith a dispersive element configured to generate a first sub-image of the scene that is dispersed; and
wherein a second of the plurality of apertures has associated therewith a second sub-image of the scene; and
downstream to the plurality of apertures and the at least one dispersive element, an image sensor configured to detect a CTIS image comprising the first and second sub-images.
